(19) United States
(12) Patent Application Publication
(10) Pub. No.: US 2002/0104759 A1
(43) Pub. Date: Aug. 8, 2002

(54) Sample analysis on a microchip

(75) Inventor: Christopher J. Backhouse, Edmonton (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: The Board of Governors of the University of Alberta and Micralyne Inc.

(21) Appl. No.: 10/013,404

(22) Filed: Dec. 7, 2001

Related U.S. Application Data
(60) Provisional application No. 60/251,521, filed on Dec. 7, 2000.

(51) Int. Cl. G01N 27/26; G01N 27/447

(52) U.S. Cl. 204/453; 204/452; 204/451; 204/601; 204/603; 204/604

(57) ABSTRACT

A microanalysis system, comprising a microchip, a common well in the microchip, and multiple wells in the microchip, each of the multiple wells being connected for fluid flow to the common well by a channel. The common well is a waste well, and the multiple wells are sample introduction wells. The common well is at the center of the microchip. The channels radiate outward from the common well, and are equally circumferentially spaced. A buffer introduction channel is provided that intersects each of the channels.

### CROSS-REFERENCE TO RELATED APPLICATIONS

This application claims the priority of U.S. provisional application No. 60/251,521 filed Dec. 7, 2000, the disclosure of which is hereby incorporated by reference.

### BACKGROUND OF THE INVENTION

Microfluidic devices offer significant advantages over conventional macroscopic methods in terms of speed, reagent usage and integration. The flexibility of this approach is such that the terms “micro-total analysis systems” and “lab on a chip” have come into use. The portion of sample to be analyzed may be defined by the intersection of two channels—the sample is loaded along one channel and the portion in the intersection is then separated. These intersection styles are varied—a “T” [1], double “T” design [2], and simple cross [3]. Although there is significant potential for their use in genetic sequencing applications (for instance [4-6]), they are particularly suited to applications which integrate PCR and capillary electrophoresis (CE). All references cited herein are listed at the end of the disclosure and are incorporated in this document by reference.

Earlier work with microfluidic devices saw the development of microfabricated devices for PCR and for integrations of PCR and CE [e.g. 18]. Taylor et al. presented their results of implementing Taqman assays implemented on micromachined structures consisting entirely of glass [8]. Northrup et al. [7] demonstrated a portable system based on micromachined silicon which incorporated Taqman assays for the rapid analysis of biological samples. These approaches of using the Taqman assay allow for a compact system with a single sample analysed within a single well. Woolley et al. [16] later demonstrated a hybrid system of Si PCR reactors and glass microfluidics for separation.

By combining PCR and CE, Ramsey et al. [9] demonstrated a system which integrated cell lysis, PCR and CE for the detection on a single chip of E.coli DNA. This approach has the advantages that it incorporates much of a simple molecular biology protocol that could be used for a medical diagnostic, while being capable of using the same reagents that would be used for that protocol in a macroscopic lab. The use of Taqman assays is likely to restrict the applications by reasons of cost and availability. The factor that is likely to decide whether microchips are used for a given application is whether the microchips can incorporate a sufficiently large number of tests such that there are benefits in cost or ease of use.

The present literature reports a number of developments working towards higher levels of integration and higher densities, in terms of cell selection and manipulation [10] and particularly arrays of CE devices [e.g. 4] and arrays of devices combining PCR/CE [e.g. 5, 11]. Existing devices also seek to improve sample concentration and separation.

### SUMMARY OF THE INVENTION

The combination of PCR and CE is appealing since it offers a means of implementing simple medical diagnostics. Of importance in these integrations is the development of a cost-effective approach for both the device and instrument. In terms of device cost, just as with conventional microelectronic microchips, it is critical to minimise the area or ‘real estate’ of the device by packing as many devices onto a substrate as possible. In terms of instrument cost, it is critical to optimize the optics and important to minimise the cost and number of the detectors. This means that there is a significant advantage to higher device density or in improved laser-induced fluorescence (LIF) signal so as to allow simpler optical arrangements. We present an arrangement of channels on a microchip that minimizes the area of the device. In addition, there are disclosed results that were obtained in microfluidic devices using a frontal analysis method that does not use intersections. This method provides advantages in both signal strength and device density.

Although microfluidic-based analyses require very little sample, they tend to require higher concentrations of reagents than those used in macroscopic systems. The use of sensitive fluorescent methods ameliorates this but even so, a sample that could be used in a macroscopic system may not provide sufficient signal in a microchip-based instrument. Methods have been reported of concentrating samples as part of the analysis and these have involved sample stacking and filters. The former method is limited by the amount of salinity of the sample, and the latter requires a more complex microchip construction. We additionally present a novel method based on a standard microchip that makes use of an on-chip concentration step. We can readily achieve a several-fold increase in concentration that also performs sample purification. This is useful phenomenon for both improving signal to noise in detection, and in concentrating samples for further analysis.

Therefore, according to an aspect of the invention there is provided a microanalysis system, comprising a microchip, a common well in the microchip for sample waste and buffer waste; multiple wells in the microchip, each of the multiple wells being connected for fluid flow to the common well by channels, each channel being uniquely associated with a respective one of the multiple wells; and each of the multiple wells providing both a sample introduction point and a buffer introduction point. According to a further aspect of the invention, the common well is at the center of the microchip. According to a further aspect of the invention, the channels radiate outward from the common well. According to a further aspect of the invention, the channels are equally circumferentially spaced. According to a further aspect of the invention, a buffer introduction channel is provided that intersects each of the channels.

According to a further aspect of the invention, there is provided a method of sample detection, comprising the steps of simultaneously running multiple sample detection methods on a single microchip using a common waste well, wherein the sample is confined during a first stage of analysis to a single channel. According to a further aspect of the invention, after a first stage of analysis in a first channel, the sample is moved elsewhere on the chip, for example to a second channel, for further analysis. The sample may also be purified within the same channel used for analysis, for example by reversal of sample movement after dilution in a waste well.

In addition, there is provided a method of concentrating a sample for analysis, the method comprising the steps of mobilizing the sample in a first direction, with the sample being spread out along the first direction; and changing the velocity of part of the sample in relation to another part of the sample to cause sample to accumulate at a sample concentration point. The change of velocity may be an acceleration of part of the sample that lags another part of the sample. The sample may be mobilized by electrical potential applied across the first direction. The sample may be spread out by an electrical potential applied with a first polarity across the sample, and a change of velocity may be applied to a part of the sample by reversing the polarity of the electrical potential.

The invention therefore provides a novel device and method for performing multiple analyses on a single chip.

### BRIEF DESCRIPTION OF THE DRAWINGS

There will now be described preferred embodiments of the invention by way of example only, without intending to limit the claims to the specific embodiment disclosed, in which like reference characters denote like elements and in which:

FIG. 1 is a top plan view of a compact arrangement for frontal analysis, illustrating the use of 1 well per sample with a central well allowing the filling of all the channels with sieving matrix (e.g. POP-6). By not requiring large and perpendicular separation channels these can be of very high device density.

FIG. 2 is a top plan view of a compact arrangement for frontal analysis including a buffer channel intersecting all the frontal analysis channels.

FIGS. 3A-3D are schematic illustrations of a method of sample concentration. FIG. 3A shows DNA entering gel. FIG. 3B shows excess DNA entering waste well according to the method. FIG. 3C shows a reversal of movements, negative ions not replenished. FIG. 3D shows spacing of positive ions, bunching of negative ions in depleted zone to cause sample concentration.

FIG. 4 shows a known microfluidic analysis chip with intersection, which shows the frontal detection point used in testing a method according to the invention.

FIG. 5 shows a conventional detector for use in the frontal detection method described herein.

FIGS. 6A-6F, are schematics showing various stages in microchip loading and separation.

FIG. 7 is a conventional microchip zone separation with LIF detection at 12 mm with 4000 V applied, the y-axis in units of V, the x-axis in seconds. The peak at 30 s is a transient caused by the powering on of the PMT and laser. The peaks near 60 and 90 s represent the primer and product peaks respectively.

FIG. 8 shows consecutive conventional zone separations (4000V applied) after consecutive injections of 12 s duration of a diluted sample showing the arrival of the primer peak after 12-24 s, and the product peak between 36 and 48 s. Time (s) on x-axis, fluorescence on 7-axis in V. Successive traces are offset by 10 s and 0.1 V. Detection occurred 12 mm along the separation channel.

FIG. 9 shows the fluorescence signal seen in frontal analysis with a diluted sample as in FIG. 8. Time(s) on x-axis, fluorescence on y-axis in V. Detection occurred immediately before the intersection on the microchip—midway between the sample and sample waste wells. The step at 11 s represents the arrival of the labelled primers, while the peak at 20 s represents the arrival of the labelled product peak. The solid line represents a least—squares fit to the data.

FIG. 10 shows a derivative of the fitted function from FIG. 9 vs. Time(s). This is a convenient way of producing a graph resembling that seen in conventional zone separations.

FIG. 11 shows a fit of a Gaussian function to a product peak from one of the traces from a diluted sample shown in FIG. 8. Time(s) on x-axis fluorescence on y-axis in V. It is apparent that this weak signal could easily be mistaken for noise.

FIGS. 12A-12J are graphs showing separations after successive injections. FIGS. 12a-e show separations as sample is moved towards the sample waste well, while FIGS. 12f-j show separations as the sample is reserved and moved back to the sample well.

FIGS. 13A-13D are schematic plan views showing events during injection and reversed injection of PCR sample in a method according to the invention, in which FIG. 13A shows sample loaded into sample well, no potentials yet applied, FIG. 13B shows sample being injected with higher mobility primers leading (on right), FIG. 13C shows sample fully loaded into injection channel, now entering sample waste well on right where infinitely diluted, FIG. 13D shows sample moving left with trailing product (reversed injection), and FIG. 13D shows a separation from an initial sample containing only primers (after a forward injection).

### DETAILED DESCRIPTION OF PREFERRED EMBODIMENTS

In this patent document, the word “comprising” is used in its non-limiting sense to mean that items following the word in the sentence are included and that items not specifically mentioned are not excluded. The use of the indefinite article “a” in the claims before an element means that one of the elements is specified, but does not specifically exclude others of the elements being present, unless, unless the context clearly requires that there be one and only one of the elements. The word “sample” is used to describe the material, including product and contaminant, that is to be analyzed. Product is the portion of the sample that is of interest and is to be retained for analysis. Contaminant is the portion of the sample that may interfere with the analysis of the product and is to be removed from the sample. Contaminant may be for example raw material from PCR, namely primers or nucleotides, or salts. The term waste well is used to differentiate the well in which dilution occurs from the well from which the sample is provided.

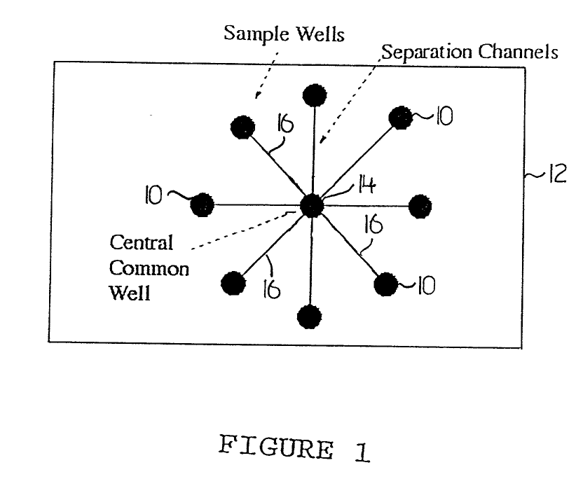

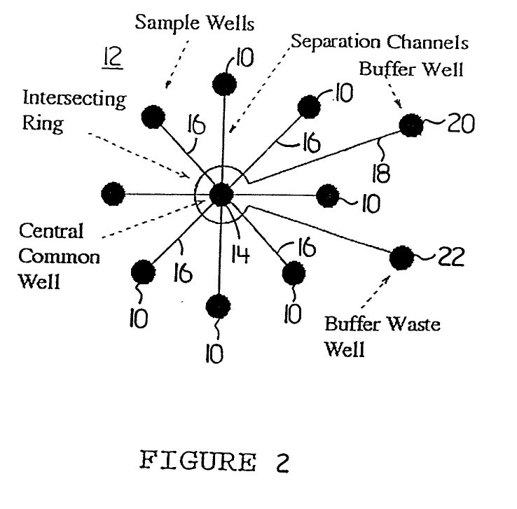

For microchip-based analysis of PCR-products, a frontal analysis separation provides similar information as a conventional zone separation but with significantly improved sensitivity and potentially with much higher device density. FIG. 1 shows a star pattern of wells 10 along the periphery of a microchip 12. Each of the wells 10 is linked for fluid flow to a central common well 14 by respective single channels 16. The channels 16 are preferably equally circumferentially spaced. All the channels 16 may be filled with a sieving medium from the central well 14, and each channel 16 may be used for a different sample. Each of the wells 10 acts as both a sample introduction point and a buffer introduction point. The common well acts as both a sample waste well and buffer waste well. Frontal analysis could readily be run on this device from samples in the peripheral wells 10, either by imaging the central region or by moving a detector such as a LIF detector about that region. The design is compact and requires only 1 well per device (1 well/sample). An alternative design in FIG. 2 shows an additional channel 18 communicating between a buffer well 20 and a buffer waste well 22 that allows any desired product to be taken to another region of the chip for further analysis (e.g. as in [3]). The further analysis may be for example a repeated frontal analysis as described herein, sequencing, analysis following further PCR, sizing, restriction enzyme digestion or any other analysis suitably carried out on a chip. Such repeated analysis has particular utility where accuracy is important, such as HIV testing, forensic analysis and cancer detection. For example, the sample may be analyzed in a first channel, then moved to a second, possibly adjacent channel, on the same chip for further analysis. Movement of the sample may be carried out by any of various methods, such as electrophoresis. More complex designs are possible following the principle of the invention. In addition to requiring ¼ the number of wells needed in a CAE array, each device requires an area 10-100 times smaller. The main limitation on density is provided by the size of the sample wells. A further reduction in size may be possible if used in conjunction with the internal PCR reaction wells demonstrated recently [5].

The channels and wells described here are, apart from the distribution and pattern of the channels and wells, made in accordance with conventional techniques and with dimensions that suit the particular application.

The technique of PCR is readily integrated onto microchips and it would appear that the future evolution of microfluidics will rely heavily upon PCR as a front-end assay. A likely scenario is that PCR based assays will be used on microchips to provide amplification, and to winnow out uninteresting samples so as to focus on the remainder with more detailed methods. As such it is likely that very large numbers of front-end PCR will be needed in microfluidic networks. The present state of the art is in integrating arrays of microfluidic devices for genetic analysis, particularly for sequencing [e.g. 4,5,6]. The disadvantage of an integrated injector is that it requires 4 wells per test (4 wells for each device), and, since the devices consist of intersecting perpendicular channels, each device takes a considerable area. As an example, the layout in the Micralyne generic microchip described below in the examples uses 0.2% of the overall area (neglecting well areas), and about 1% with sample well areas. Although Harrison et al. [1] reported a microchip-based frontal analysis, their method was an indirect one that was based on the use of an intersection and would not have the same advantages in the high density integrations of PCR and CE.

The Taqman assay kits produced by PE Biosystems allow implementation with a similarly high density by allowing the detection with only one sample per well. In that approach a successful amplification activates fluorophores which lead to the well becoming fluorescent. Unfortunately these assays are specific to a number of targets. On the other hand, the frontal analysis allows the use of conventional reagents at a lower cost.

The present frontal analysis technique may readily be integrated into a more complex microfluidic system. As one example, a very large number of samples may be analysed simultaneously with an initial PCR amplification step using frontal analysis on a single microchip using the design shown in FIG. 1 or 2, and the resulting products may then be extracted for further analysis following the method demonstrated by Waters et al. [3] —a single channel could intersect all the sample channels so that any product could be selected and extracted. A disadvantage of the method proposed by Waters et al. is that their separations must all be done in the same separation channel—this introduces a major delay and will be limited by the number of times the channel can be re-used before being reconditioned or refilled. In our experience, a gel can be used a dozen times or so before being replaced. The presently proposed method could be used with far larger numbers of samples, while allowing further analysis of any of them.

With the stronger signals produced by this method considerable leeway may be afforded in the design—either through simpler optical designs, fewer PCR steps, or less reagents required. The conventional zone separation method will be required for more complex samples, such as for sequencing. Microchip-based frontal analysis is likely to be useful in many PCR-based protocols allowing simpler instrumentation and higher density microchips, leading to a reduction in both instrument and microchip cost.

According to a further invention, there is now described a microchip-based means of concentrating a sample by using sample stacking effect based on molecular valving.

Although one of the strengths of microchip-based approaches is that the amount of sample required is very low, microchip-based analysis tools tend to require higher concentrations of reagents than those used in macroscopic systems. The use of sensitive fluorescent methods ameliorates this but even so, the use of a strong PCR product may not provide sufficient signal in a microchip-based instrument. Several methods have been reported of methods of concentrating samples as part of the analysis and these have involved sample stacking and filters. The former method is limited by the amount of salinity of the sample, and the latter requires a more complex microchip construction. We present a novel method based on a standard microchip that makes use of an on-chip concentration step. We believe on reasonable grounds this method will enable the analysis of weak signals.

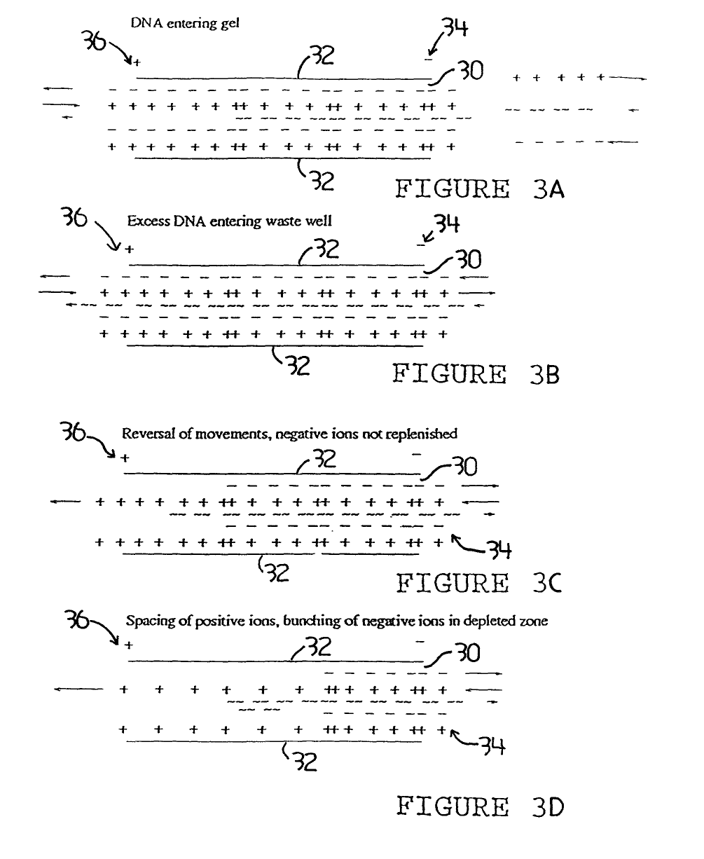

As shown in FIG. 3A, DNA can be loaded into a separation gel in a channel 30 defined by walls 32 by applying a voltage along the channel. In FIG. 3A, the negative potential is at the right side. Due to the mobilizing force of the electric potential, DNA, indicated by the tilda ˜ and negative ions move from the sample well 34 (−) towards the waste 36 (+), while the positive ions move from the sample waste well 36 to the sample well 34. After a few seconds, as shown in FIG. 3B, the DNA begins to enter the sample waste well 36. In both FIGS. 3A and 3B the stream of ions in continuously replenished. Those ions leaving the channel are lost into the infinite reserviour of their destination well. Debye screening, which is known in the art, prevents their recovery.

With the reversal of polarities the species reverse direction, as shown in FIG. 3C. If the sample waste well 36 does not contain a concentration of negative ions then the supply of negative ions is not replenished as the species reverse direction. This leads to the formation of a depletion region containing fewer charge carriers as the negative species move off—this in turns creates a higher electric field across the depletion region and the slower DNA molecules fall behind the faster negative ions. As the depletion region widens, the electric field at the tail end of the DNA becomes stronger than the electric field across the negative ions. This increases the speed of the trailing DNA, forming a domain with greatly increased concentration of DNA as shown in FIG. 3D.

Increasing the speed of the trailing sample is an example of a change of velocity of part of the sample in relation to another part of the sample, which has the effect of causing sample to accumulate at a sample concentration point, namely at the trailing end of the sample.

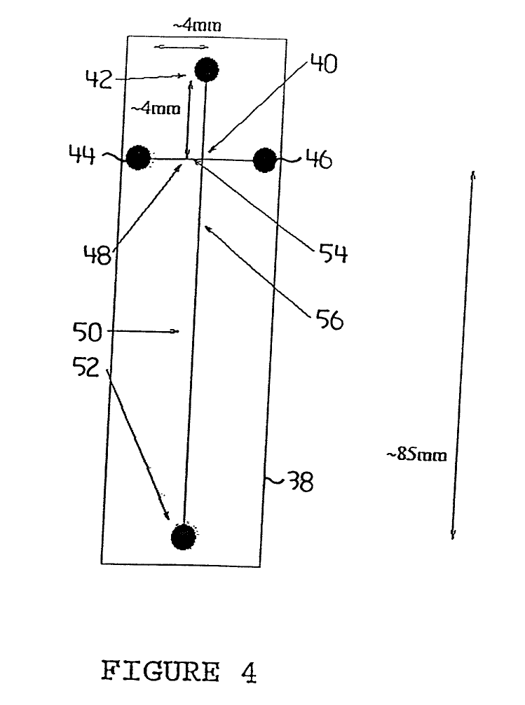

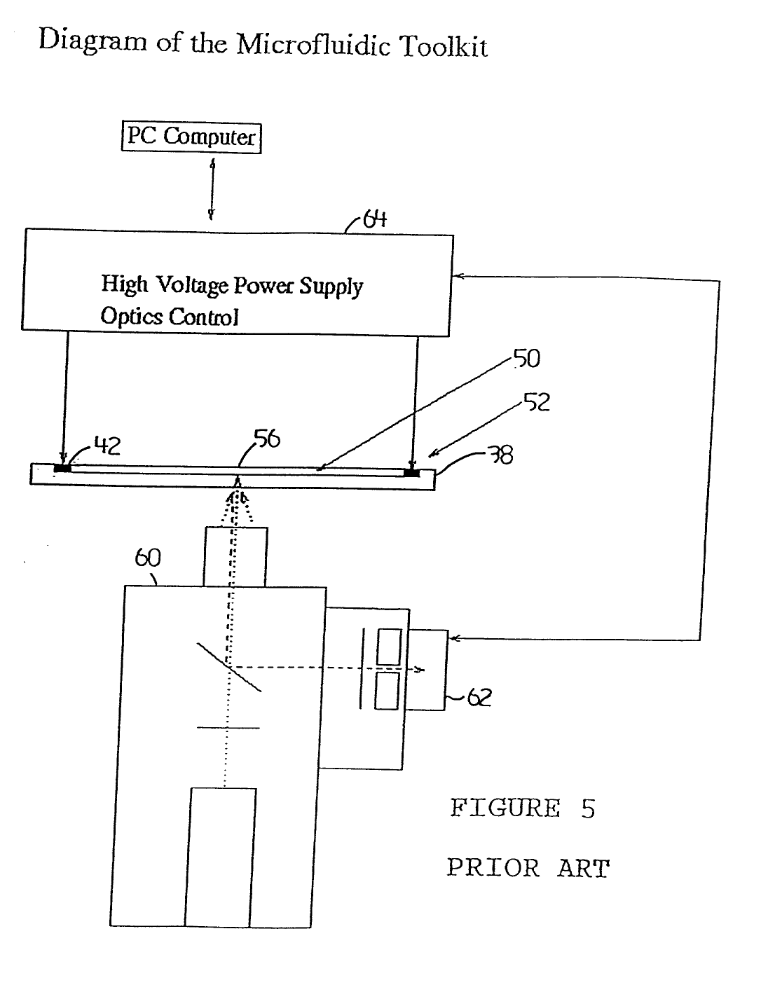

Detection of the concentrated sample may be carried out by causing concentration to occur at an intersection of a conventional microchip 38 such as the one shown in FIG. 4, which shows a microchip 38 with buffer well 42 about 4 mm from intersection 40, sample well 44 also about 4 mm from intersection 40, sample waste well 46, injection arm 48, separation channel 50, about 85 mm long, buffer waste well 52, frontal detection point 54 and conventional method detection point 56. Conventional detection techniques may then be used to detect the concentrated sample. Care must be taken to ensure the concentrated sample is placed at the intersection. The concentration region may be sharp, with little sample beyond the boundaries of the concentration region. Detection of the concentrated sample may be used to detect the entry of the concentrated sample in the intersection, and hence detection is used twice, once at the intersection, and again during separation in a cross-channel. Preferably, two detection arrangements are used each having a conventional construction as illustrated in FIG. 5. One is placed at the intersection 40 of the two channels of the microchip 38 shown in FIG. 4 and the other in the conventional detection area 56 in FIG. 4.

This technique of on chip sample concentration will assist in solving one of the fundamental problems related to the use of microchips—increasing the sample concentration to aid detection.

### EXAMPLES

Testing of the efficacy of frontal analysis was carried out using the Microfluidic Tool Kit (μTK) manufactured by Micralyne (formerly the Alberta Microelectronic Corporation (AMC)). The μTK is shown in FIG. 5 and consists of a laser-induced fluorescence (LIF) inverted confocal microscope 60 with photomultiplier tube (PMT) 62, integrated modular high voltage supplies and control system 64. The LIF system 60 provides excitation at 635 nm and detection at 670 nm (as used for the dye Cy-5). The μTK was operated by means of either a compiled LabView interface (supplied by Micralyne) or under a program written in C (Unix based) with the same functionality under either system. The microchips used here were the Simple Cross injector design manufactured by Micralyne (nominal channel dimensions of 50 μm wide and 20 deep, as shown in FIG. 4).

With programmable PMT gain, the μTK 60 acquired the LIF signal at 50 Hz and these data were recorded to hard disk on the host computer 64 by the control program. Following the run, data analysis was performed by applying the 21-point Savitsky-Golay method [12] to smooth the data and, optionally, greatly reduce the file sizes. No attempts were made to remove isolated noise spikes from the data prior to smoothing although such spikes can generate peaks of realistic appearance after smoothing. The smoothing program wrote a Maple (Waterloo Software, Waterloo, ON) script to display and further analyse the data in an automatic fashion.

The PCR product was amplified from yeast genomic DNA template and primers specific to the SCO1 gene. The primers were obtained from Synthetic Genetics (San Diego, Calif.) and were labelled with Cy5 at the 5′ end. (PCR REAGENTS: Taq polymerase (Gibco BRL), dNTP) The PCR reaction was run in a MJ unit (Fisher Scientific) under standard conditions for PCR [15]. The size of the resulting product (322 base pairs) was verified by comparison with a X174HaeIII size standard, as separated in conventional system using an agarose gel with ethidium bromide. A photograph taken of the agarose gel under UV illumination following a 45 minute separation with a TAE (tris(hydroxymethyl)aminomethane, acetate, and ethylenediaminetetraacetic acid) buffer and an applied potential of 90V showed that the agarose gel does not resolve the primers.

The microchip was loaded with POP6 (PE Biosystems), a seiving medium, by syringe, and the wells were filled with running buffer (PE Biosystems). An aliquot of 1.5 μl of the PCR product was mixed with 3 μl of template suppression buffer (TSR, PE Biosystems) and heated to 95° C. for 3 minutes and then quenched in an ice-water bath to provide single-stranded PCR product. Aliquots of this preparation were added to the sample well of the microchip (as shown on FIG. 4.) typically with 1 μl of prepared sample and 3 μl of running buffer (TSR, PE Biosystems), resulting in a 16 fold dilution from the original PCR mixture. The approach of using POP6 was found to be effective and convenient while providing both reproducibility and the ability to empty and refill the microchips indefinitely. The double-stranded PCR product could easily be used directly (without the TSR and heating step described above) providing a stronger signal, but would produce a peak much closer to that of the primers.

### Results

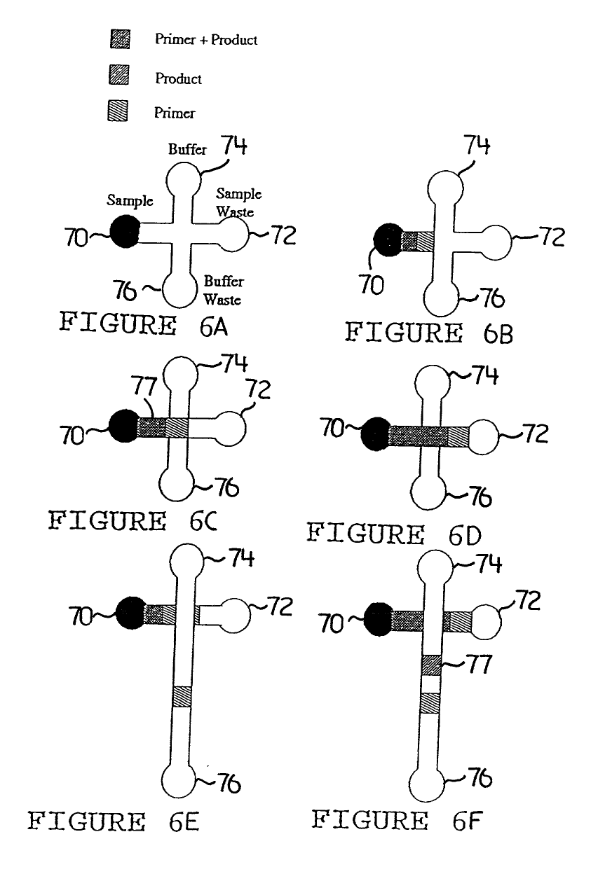

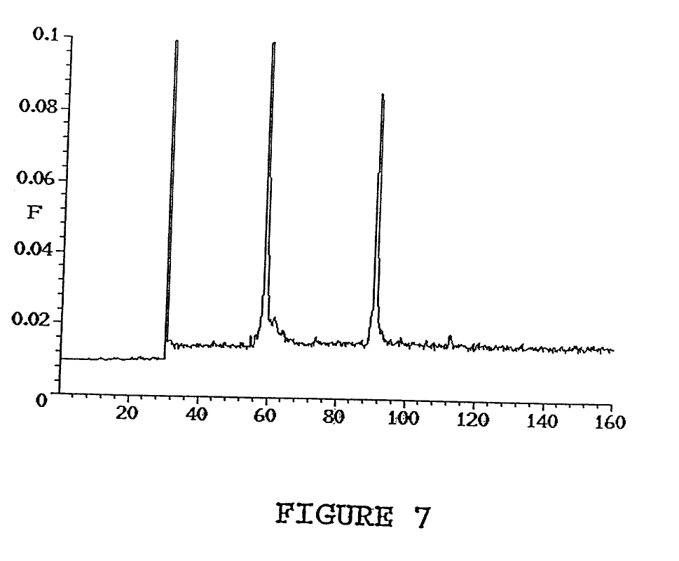

As an example of conventional microchip separations, an aliquot of a relatively concentrated sample (prepared with 3 μl PCR reaction mixture, 1 μl of TSR and 1 μl of running buffer), was added to a sample well 70 of a microchip, with sample waste well 72, buffer well 74 and buffer waste well 76 as shown in FIG. 6A. A potential of 320V was applied across the injection (short) channel of the microchip (separation channel left floating), causing the DNA77 to move from the negatively charged sample well towards the sample waste 72 at ground (FIGS. 6B-6D). After 60s this voltage was removed (FIG. 6D) and a negative voltage was applied to the buffer well 74 (−4000V), with the buffer waste 76 held at ground. This separated the sample plug 77 (at the intersection) into its constituents (FIG. 6F). The DNA within the intersection can be analyzed at any time by removing the injection potential and applying a voltage to the buffer well with the buffer waste at ground. FIG. 7 shows an electropherogram from a separation of the PCR products, with the detection system placed only 12 mm downstream of the intersection. The initial 30 s were recorded during the injection step, followed by transient at the start of the separation step as the photomultiplier tube is powered on—this is a convenient marker for the beginning of the separation step. The first peak, at about 60 s (˜30s into the separation run) represents the passage of the fluorescently labelled primers (24 bp) and the second at ˜90 s (about 60 s into the run) represents the passage of the PCR product (322 bp). The DNA components have velocities of 0.53 and 0.26 mm/s for the primer and product respectively at this applied field of 470 V/cm, corresponding to mobilities of 1.1×10⁻⁴ cm²/Vs and 5.5×10⁻⁴ cm²/Vs respectively. (Uncertainties are about 10% and are due almost entirely to the run-to-run uncertainties in positioning the detection optics on the microchip.)

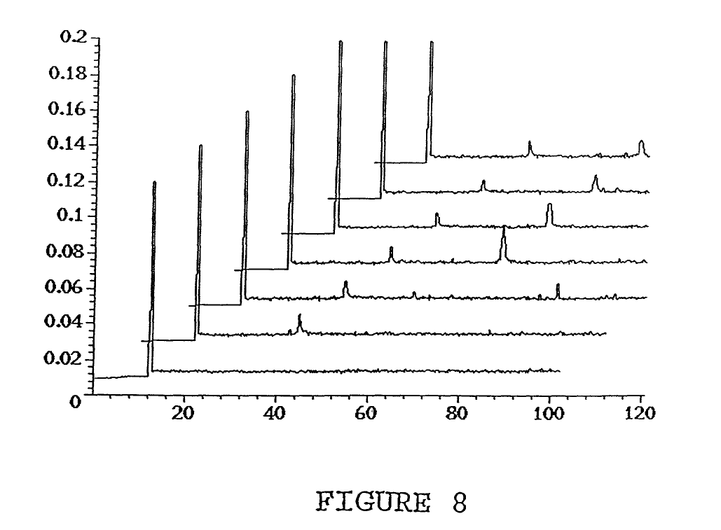

In a subsequent experiment, 7 sequential analyses were performed wherein an aliquot of 1 μl of the prepared sample was added to the sample well along with 3 μl of running buffer. FIG. 8 shows the 7 successive 90 s separations, each preceded by a 12 s injection step. In the first run (bottom trace), neither primer nor product have reached the intersection by the time the separation is started and so no peaks are apparent during the separation. This would correspond to starting a separation after injecting to the stage shown in FIG. 6B (hence no peaks are detected). In the second and following traces the primer peak is now present (corresponding to FIG. 6C and FIG. 6D). In the 4^{th} and following traces the product has had time to reach the intersection and so the product peak is evident (corresponding to FIG. 6D and 6F). It should be noted that with the dilution of the sample, the signal is quite weak despite the enhancement of the Savitsky-Golay method and the gain of the PMT in the LIF system being set to its maximum—the peaks were difficult to resolve before smoothing. This plot clearly shows that the two types of DNA reach the intersection at between 20-24 s (primer) and 36-48 s (product) of elapsed injection time. It is also worthy of note that this procedure results in additional dilution of the sample and the additional running buffer appears to reduce sample-stacking effects—the resulting signals are considerably reduced from those in FIG. 7.

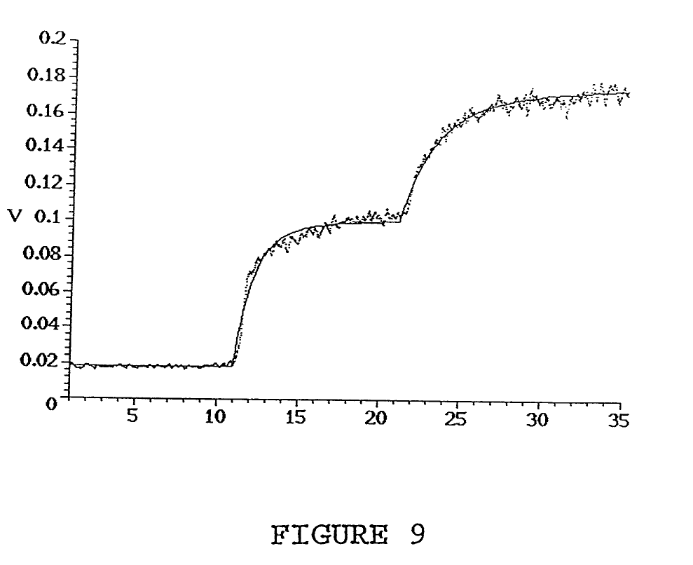

As can be seen in FIGS. 6A-6D, the injection of the sample is itself a type of separation, with the faster primers preceding the longer PCR product. An experiment was devised with detection at the channel intersection, and the sample of FIG. 8 (containing both primers and product) being drawn through the injection channel with an applied potential of 320V. The results, shown in FIG. 9, were verified by acquiring data both before the runs of FIG. 8 and after, each time with a chip prepared in the same manner. The arrival of the two types of DNA can clearly be seen in steps at about 11 and 21 s. The signals obtained in the injection arm are considerably stronger than those of a conventional separation, despite all other parameters (sample dilution and PMT gain) being constant. The steps were readily distinguished even without the Savitsky-Golay filtering.

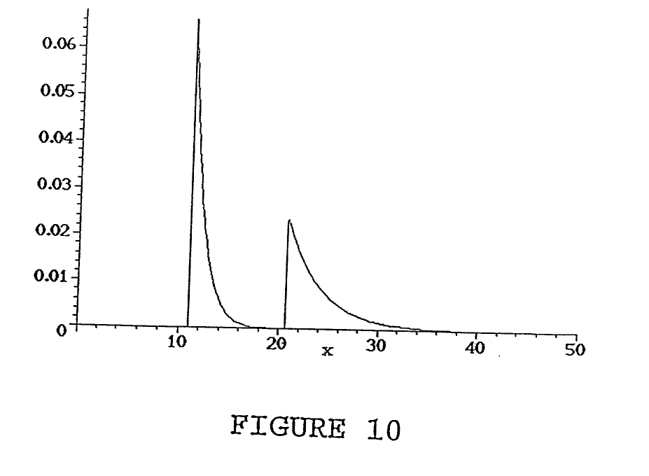

As shown in FIG. 9 (dashed line), the data were fitted with a function having two exponential relaxation terms. In FIG. 10, the difference between successive values of the fitted function versus time are plotted to produce an approximation of the conventional double peak. Using this function and given that the detection was at the intersection, a separation distance of approximately 4 mm, these results predict that a conventional separation with detection at 12 mm under the same field (approx 320 V/cm) would predict mobilities of about 9.1×10⁻⁵ cm²/Vs and 4.8×10⁻⁵ cm²/Vs—in good agreement with FIGS. 7, 8. As can be seen by comparing FIG. 8 (zone separation method) and FIG. 9 (frontal method), the frontal analysis method seems to be less affected by noise and this would be expected to lead to a different in limit of detection (LOD) for the two methods. This approach may be used reliably for several types of DNA as long as they were sufficiently different in size. PCR-based techniques could be tailored for this approach through the choice of primers giving appropriate sizes of product.

In our early analysis, we attempted to fit, for each species, a model function consisting of 0 well before the arrival of the DNA ‘front’, a constant following the arrival and with a Gaussian drop-off preceding the front to simulate diffusive broadening in transit. However, these models did not fit as well as a single exponential relaxation model with 0 well before arrival, A(1−exp(a(x−vt)) just before arrival, and A after arrival. This difference in behaviour is likely due to effects at the sample well/channel interface. Nevertheless, even without a more detailed understanding of the mechanism, the arrival times of the fronts provide information on the mobility of the DNA species.

The raw materials used for the PCR reaction contained 5 pmol of each fluorescently labeled primer in 50 μl. After the reaction, 1 μl of this solution, further diluted by a factor of 8 will contain 0.0125 pmol, or 12.5 fmol of fluorescently labeled primer and product DNA. Once loaded with even this 1 μl of dilute sample, the microchip contains enough sample to make many runs—in order to estimate how many, and to estimate the limit of detection (LOD) of the system, fluorescence measurements were made in the injection arm over several minutes. It was determined that the fluorescence decreased by a factor of two during an injection of 300 seconds duration indicating that about half of the 12.5 fmol of sample (primer and product) in the well had been used. In that period of time, given the mobilities determined here, the intersection could have been filled approximately 2500 times.

To a first approximation we estimate that ½×1/2500×12.5 fmol=2.5 amol, or 1.5 million fluorophores, are injected in each plug. Since the peak heights of the primer and product peaks are approximately equal (as in FIG. 7), each injected plug contains approximately 0.75 million fluorophore-labelled product DNA molecules.

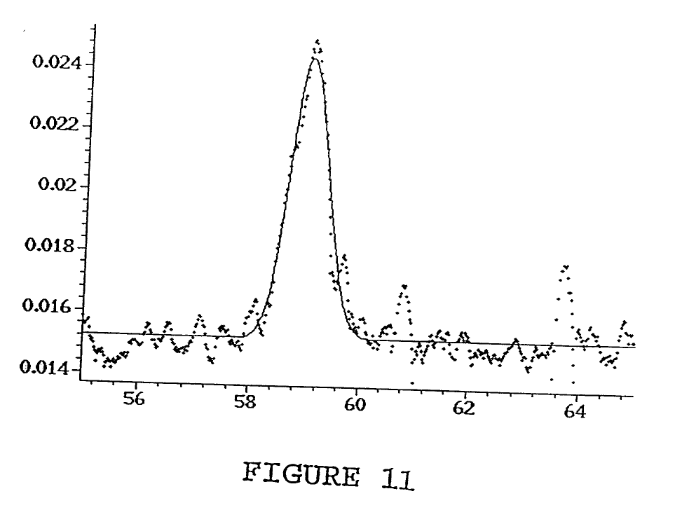

Knowledge of the quantities of fluorophores injected allows LODs (3σ) to be calculated by standard signal-to-noise (S/N) graphical techniques. For the zone separation of FIG. 11, noise is defined as the standard deviation of the baseline from 60.0 −65.7 s while signal is the peak height from the same baseline; S/N=14.6. The LOD is thus 0.75×10⁶×3/14.6=1.5×10⁵ molecules.

For the frontal analysis separation in FIG. 9, it is the second, slower front (amplified DNA) which is of interest: noise is defined as the standard deviation of the sloping section of the primer plateau from 19.0 to 21.2 s while signal is defined as the height of the front, averaged from 29.5 to 33.7 s, as measured from the primer plateau; S/N=34.9. We do not calculate an LOD here as it is not readily apparent how to define the LOD in conjunction with the frontal analysis method.

By contrasting the S/N values obtained with the standard graphical technique applied to the frontal and zone separation methods using the same sample, it may be stated that the frontal analysis method is ˜2.4 times more sensitive. These findings corroborate the visual impression that the frontal method is more sensitive: since frontal analysis produces a continuous signal rather than a brief pulse, it is better able to determine amplitudes in the presence of noise.

A second approach to quantifying the sensitivity is to use the parameters and their uncertainties as provided by a non-linear least squares algorithm. This algorithm, the Levenberg-Marquardt method [14], uses the residuals of the fit to estimate the uncertainty in the parameters in the model function. Table 1 shows the parameters from the fitted curves of FIGS. 9 and 11. In corroboration of the standard graphical method (above), Table 1 shows a three-fold improvement in S/N with the frontal method over the zone separation method by the Levenberg-Marquardt method. While both the graphical and Levenberg-Marquardt least squares analysis methods yield similar S/N improvements for the frontal analysis vs. the zone separation format, the latter data analysis method is more sensitive. The S/N arising from the least squares method is over 4 times higher than that from the standard graphical method, thus giving a LOD of 0.75×10⁶×3/66=3.5×10⁴ labelled molecules in the initial injection plug.

With the nominal channel dimensions, and a LIF spot size of 10 μm, the LIF detection system will detect about ⅛th of the fluorophores passing the detection point. This suggests that a value for the LOD of approximately 5000 labelled molecules could be reached by either reducing the channel dimensions of applying sample focusing techniques to better detect these fluorophores.

In the plot of FIG. 9 it can be seen that the simple exponential decay model only approximates the experimental data—indicating that a more detailed model is required, likely one that involves not only electrophoretic behaviour within the channel, but also sample/channel interface effects. Since the Levenberg-Marquardt method uses the residuals of the fit to estimate the uncertainty in the parameters, a more accurate model function would give even lower uncertainties—the results of Table 1 are therefore pessimistic in terms of the performance of the frontal analysis method.

With the dilute samples used here, the results of the conventional zone separation (FIG. 11) show that the amplitude of the DNA peak is only about three times that of nearby background fluctuations (see also the large noise peak at 100 s in the third trace from the bottom in the composite plot of FIG. 8). Although most such spikes can be removed by checking that the apparent peak width is appropriate, a group of such spikes is difficult to categorise, and these problems could be compounded if an RC-filter is used to filter noise.

With the stronger signals produced by this method considerable leeway may be afforded in the design—either through simpler optical designs, fewer PCR steps, or less reagents required. There has recently been considerable development of methods to enhance the signal strength in microfluidic systems. Jacobsen and Ramsey [19] as well as Haab and Mathies [13] have demonstrated the use of focusing methods to stream the fluorescent material through the detection area in order to improve the detection efficiency. Alternately, the sample concentration method used by Khandurina et al. [17] could be used to improve the signal when using dilute samples. The present method offers improvements in both density and signal while potentially being useable in conjunction with these methods. While the conventional zone separation method will be required for more detailed analyses, this microchip-based frontal analysis method is likely to be useful in many PCR-based protocols allowing simpler instrumentation and higher density microchips, leading to a reduction in both instrument and microchip cost.

TABLE 1
Comparison of Zone and Frontal Methods.

| | Zone Separation | Frontal Analysis |
|---|---|---|
| Method: | (FIG. 11) | (FIG. 9) |
| Standard Graphical Method: | 14.6 | 34.9 |
| Signal/Noise (S/N): | | |
| Levenberg-Marquardt: | 9.25 ± 0.14 mV | 89.1 ± 0.40 mV |
| Product Amplitude: | 66 | 220 |
| Signal/Noise (S/N): | | |

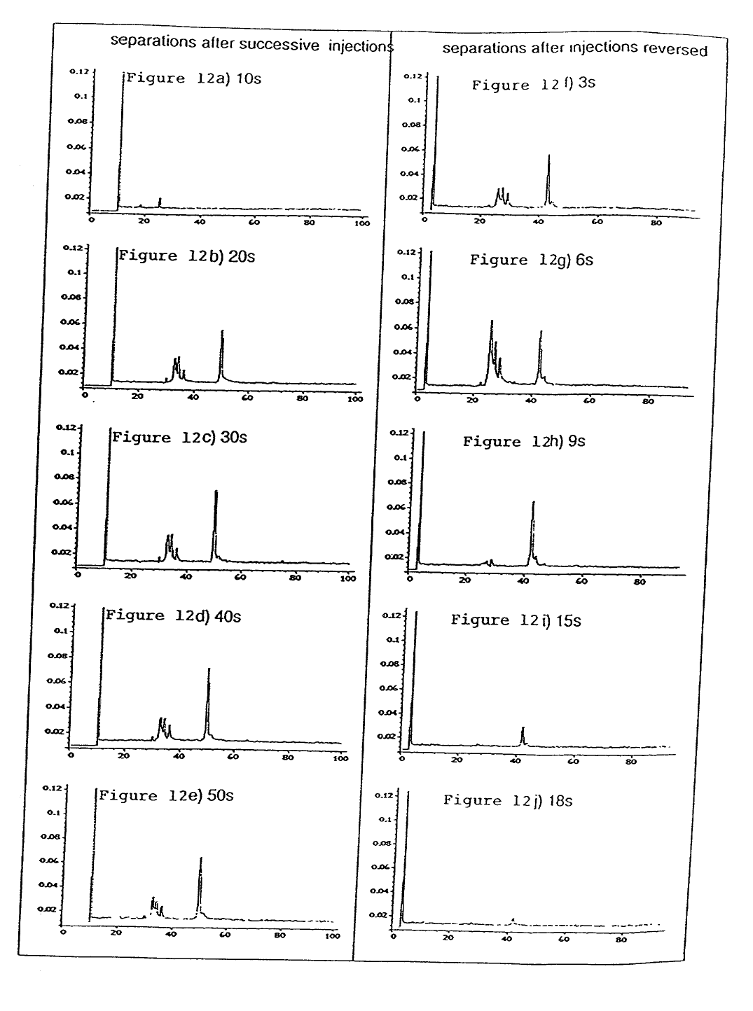

For the on-chip concentration technique, a series of separations of a PCR sample from an amplified portion of the yeast nuclear genome were carried out. FIGS. 12A-E show separations as sample is moved towards the sample waste well, while FIGS. 12F-J show separations as the sample is reserved and moved back to the sample well.

It is believed that the frontal method may be preferably applied with an electrical detection method by simply measuring the current flow rather than measuring fluorescence.

The separation and concentration techniques described herein may be applied to a wide variety of species spanning not only species such as metal and other ions, but virtually any chemical or biochemical, including proteins, DNA, RNA.

DNA is readily moved electrically (electrophoretically in the exemplary frontal method described here) but can also be moved under physical pressure, electro-osmosis, dielectrophoresis, optical manipulation, or attachment to a bead or tag that can be manipulated magnetically, electrically or optically. The most common methods are electrophoretic and, in second place, pressure driven movement (in liquid chromatography).

A sample to be analyzed on the chip described here may be a sample obtained from a PCR step carried on in conventional manner off chip or on chip. When the PCR step is carried out on chip, it may be carried out in a well using conventional methods, in which the entire chip is thermally cycled, or in a channel in which the PCR components are thermally cycled by joule heating, such as by irradiating the PCR. The PCR step may be carried out in any one or more of the peripheral wells. Methods of carrying out PCR, both on chip and off chip are well known.

The chip described here with multiple channels has particular utility for use with analytical methods that do not require the use of intersections, as for example frontal analysis, that is, the analysis is confined to a single channel, with detection at a point in the channel. Another method that may be used on the chip is the sample purification method described in the provisional application from which priority is claimed and as described in a co-pending application filed on the same date as this patent document (and published in Sample Purification on a Microfluidic Device Electrophoresis 2001, 22 3868-3875). In that technique, a method of sample purification comprises the steps of moving product and contaminant along a first channel in a first direction at different speeds for the product and contaminant until product and contaminant enter a waste well. Then the direction of movement of the product and contaminant is reversed to separate product from the contaminant. After product is separated from contaminant it may be detected using conventional detectors. To ensure effective dilution of contaminant, it is preferred that there be a delay or pause between forward movement of the sample and reverse movement. The method has particular utility for sample obtained through polymerase chain reaction, such as when the product is DNA and the contaminant is PCR raw material. For many samples, separation by application of an electric potential along the channel is preferred. Separation of the sample may also be followed by a further separation along a channel at right angles to the initial injection channel.

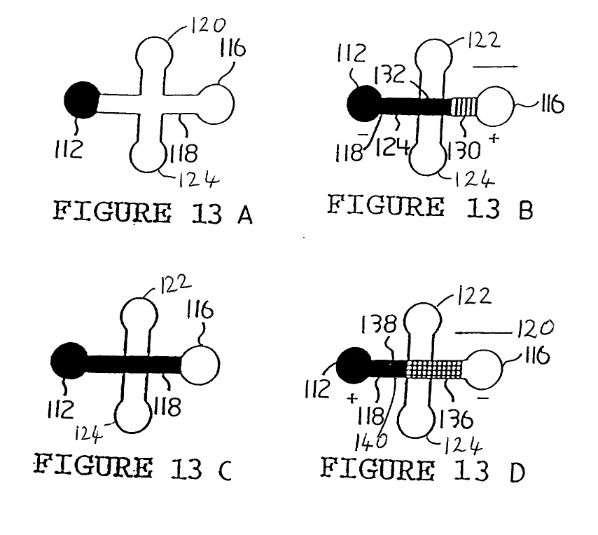

Thus, frontal analysis, which is carried out in a single channel, may be carried out on a microchip. Use of a single channel eliminates space-consuming intersections. FIGS. 2A and 2B illustrate how a frontal analysis may be carried out. FIGS. 13A-13D illustrate method steps carried out on the microchip shown in FIG. 1 or 4, but the method steps of FIGS. 13A-13D may be carried out on a microchip having a single channel, with detection at the detection point 54 shown in FIG. 4 or a corresponding point of the channels shown in FIG. 1 or 2. In FIG. 13A, sample well 112 is loaded with sample from a PCR reaction. Black is used to represent the sample, which contains product, primer and salts. The injection channel 118 is loaded with a conventional sieving matrix. Since the sieving matrix hinders diffusion, the sample does not move into the microchannel 118 until a voltage is applied. During the injection phase (FIG. 13B), a potential is applied between the sample well 112 and sample waste well 116 to drive product and primer along the channel towards the sample waste well 116. The primers (and salts) with their higher electrophoretic mobilities will lead the way toward the sample waste well 116, creating a leading region 130 with primers only and a trailing region 132 with both product and primers.

In this frontal analysis method, the results of the PCR may be analysed by monitoring a fluorescence signal from the product versus time from a point 140 in the injection channel 118. The detection is carried out using conventional detectors located at the detection point. Such detectors are available from many companies, including Micralyne Inc. of Edmonton, Alberta, Canada. This method is suitable for some medical diagnostics, which are based on the presence or absence of an amplifiable sequence, and allows both a higher channel density per chip and higher signal-to-noise ratio than do common protocols involving intersecting channels.

The sample wells on a microfluidic chip typically contain vastly more (ca. 3000-fold excess) sample than is needed for a single microchip-based analysis. This means that the sample well 112 can be considered to be an infinite reservoir. A frontal electrophoretic separation from any such a reservoir can readily isolate the faster moving components from the remainder of a sample but cannot isolate the slower component (as shown in FIG. 13B). In some cases, contaminants such as salts and primers can be separated electrophoretically, but often the contaminants prevent efficient separation, leading to dilution or loss of sample. A method of removing the contaminants is needed that avoids degradation of the product. This is a significant problem in applications that require the isolation (purification) of the slower component prior to further processing and must be overcome in order to attain higher levels of integration on microchips.

As shown in FIGS. 13A-13D, a process of sample separation starts with moving a sample of product along with contaminant (primer and salts) along channel 118 from sample well 112 to sample waste well 116 by application of a potential between the wells 112, 116. The product and contaminant move at different speeds until contaminant separates from the product and is lost by dilution in the waste well 116 (FIG. 13C). Dilution may also occur for example by removal of material at the waste well, for example by rinsing. Next, preferably after a delay, the potential applied across the wells 112, 116 is reversed to reverse the direction of movement of the product and contaminant. Reversal of the direction of movement separates product from the contaminant (FIG. 13D) resulting in product at 136 being separated to be available for detection in the channel 118. A second stage of separation may be obtained by isolating the separated product by drawing the separated product into a channel 120 intersecting the channel 118 and applying a potential between a buffer well 122 and a buffer waste well 124.

Many simultaneous separations and analyses may be carried out at the same time on the same chip using multiple channels.

Immaterial variations on the embodiments disclosed here are intended to be included within the scope of the invention.

References:

1) D. J. Harrison, A. Manz, Z. Fan, H. Ludi, H. M. Widmer, “Capillary Electrophoresis and Sample Injection Systems Integrated on a Planar Glass Chip”, Anal. Chem. 64 1926-1932 1992

2) N. Chiem, D. J. Harrison, “Microchip-Based Capillary Electrophoresis for Immunoassays: Analysis of Monoclonal Antibodies and Theophylline”, Anal. Chem. 69 373-378 1997

3) L. C. Waters, S. C. Jacobsen, N. Kroutchinina, J. Khandurina, R. S. Foote, J. M. Ramsey, “Multiple Sample PCR Amplification and Electrophoretic Analysis on a Microchip”, Anal. Chem. 70 5172-5176 1998

4) Y. Shi, P. C. Simpson, J. R. Scherer, D. Wexler, C. Skibola, M. T. Smith, R. A. Mathies, “Radial Capillary Array Electrophoresis Microplate and Scanner for High-Performance Nucleic Acid Analysis:, Anal. Chem. 71 5354-5361 1999

5) E. T. Lagally, P. C. Simpson, R. A. Mathies, “Monolithic Integrated Microfluidic DNA Amplification and Capillary Electrophoresis Analysis System”, Sensors and Actuators B 63 138-146 2000

6), C. J. Backhouse, M. Caamano, F. Oaks, E. Nordman, A. Carillo, B. Johnson and S. Bay,“DNA Sequencing in a Monolithic Microchannel Device”, Electrophoresis 21 150-156 2000

7) M. A. Northrup, B. Benett, D. Hadley, P. Landre, S. Lehew, J. Richards, P. Stratton “A Miniature Analytical Instrument for Nucleic Acids Based on Micromachined Silicon Reaction Chambers”, Anal. Chem. 70 918-922 1998

8) T. B. Taylor, S. E. Harvey, M. Albin, L. Lebak, Y. Ning, I. Mowat, T. Scluerlein, E. Principe, “Process Control for Optimal PCR Performance in Glass Microstructures”, Biomedical Microdevices 1 65-70 1998

9) L. C. Waters, S. C. Jacobsen, N. Kroutchinina, J. Khandurina, R. S. Foote, J. M. Ramsey, “Microchip Device for Cell Lysis, Multiplex PCR Amplification, and Electrophoretic Sizing”, Anal. Chem. 70 158-162 1998

10) P. C. Li, D. J. Harrison, “Transport, Manipulation, and Reaction of Biological Cells On-Chip Using Electrokinetic Effects”, Anal. Chem. 69 1564-1568 1997

11) J. Khandurina, T. E. McKnight, S. C, Jacobsen, L. C. Waters, R. S. Foote, J. M. Ramsey, “Integrated System for Rapid PCR-Based DNA Analysis in Microfluidic Devices”, Anal. Chem. 72 2995-3000 2000

12) A. Savitsky, M. Golay, “Smoothing and Differentiation of Data by Simplified Least Squares Procedures”, Anal. Chem. 36 1627-1639 1964

13) Brian B. Haab and Richard A. Mathies, “Single-Molecule Detection of DNA Separations in Microfabricated Capillary Electrophoresis Chips Employing Focused Molecular Streams”, Anal. Chem. 71 5137-5145 1999

14) W. H. Press, B. P. Flannery, S. A. Teukolsky, W. T. Vetterling, “Numerical Recipes in C”, Cambridge University Press, Cambridge, UK 1990

15) D. M. Glerum, I. Muroff, C. Jin, A. Tzagaloff, “COX15 Codes for a Mitochondrial Protein Essential for the Assembly of Yeast Cytochrom Oxidase”, J. Biol. Chem. 272 19088-19094 1997

16) A. T. Woolley, D. Hadley, P. Landre, A. J. de Mello, R. A. Mathies, M. A. Northrup, “Functional Integration of PCR Amplification and Capillary Electrophoresis in a Microfabricated DNA Analysis Device”, Anal. Chem. 68 4081-4086 1996

17) J. Khandurina, S. C. Jacobson, L. C. Waters, R. S. Foote, J. M. Ramsey, “Microfabricated Porous Membrane Structure for Sample Concentration and Electrophoretic Analysis”, Anal. Chem. 71 1815-1819 1998

18) J. Cheng, M. A. Shoffner, G. E. Hvichia, L. J. Kricka, P. Wilding, “Chip PCR: 2. Investigation of Different PCR Amplification Systems in Microfabricated Silicon-Glass Chips”, Nucleic Acids Research 24 380-385 1996

I claim:

1. A microanalysis system, comprising:
a microchip;
a common well in the microchip for sample waste and buffer waste;
multiple wells in the microchip, each of the multiple wells being connected for fluid flow to the common well by channels, each channel being uniquely associated with a respective one of the multiple wells; and
each of the multiple wells providing both a sample introduction point and a buffer introduction point.

2. The microanalysis system of claim 1 in which the common well is a waste well, and the multiple wells are sample introduction wells.

3. The microanalysis system of claim 1 in which the common well is at the center of the microchip.

4. The microanalysis system of claim 3 in which the channels radiate outward from the common well.

5. The microanalysis system of claim 4 in which the channels are equally circumferentially spaced.

6. The microanalysis system of claim 1 further comprising a buffer introduction channel intersecting each of the channels.

7. A method of sample detection, comprising the steps of simultaneously running multiple sample detection methods on a single microchip using a common waste well, wherein each sample is confined during a first stage of analysis to a single channel.

8. The method of claim 7 in which, after a first stage of analysis in a first channel, the sample is moved out of the first channel for further analysis.

9. The method of claim 8 in which the sample is moved into a second channel for further analysis.

10. The method of claim 8 in which sample is purified before detection in the channel in which it is analyzed.

11. The method of claim 8 further comprising the step of carrying out PCR on the chip to produce sample for analysis.

12. A method of concentrating a sample for analysis, the method comprising the steps of:
mobilizing the sample in a first direction, with the sample being spread out along the first direction; and
changing the velocity of part of the sample in relation to another part of the sample to cause sample to accumulate at a sample concentration point.

13. The method of claim 12 in which the change of velocity is an acceleration of part of the sample that lags another part of the sample.

14. The method of claim 12 in which the sample is mobilized by electrical potential applied across the first direction.

15. The method of claim 12 in which the sample is spread out by an electrical potential applied with a first polarity across the sample, and a change of velocity is applied to a part of the sample by reversing the polarity of the electrical potential.
